(19) United States
(12) Patent Application Publication
(10) Pub. No.: US 2006/0218138 A1
(43) Pub. Date: Sep. 28, 2006

(54) System and method for improving search relevance

(75) Inventor: Christopher Weare, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/089,327

(22) Filed: Mar. 25, 2005

(51) Int. Cl. G06F 17/30

(52) U.S. Cl. 707/5

(57) ABSTRACT

A system and method for performing context based document searching is provided. A grid of content tiles is constructed corresponding to a desired concept space. Each content tile is assigned a content tag and is associated with a series of feature values. The feature values are trained to correspond to various regions of the content space. Documents are associated with one or more content tags based on a comparison of document feature values with content tile feature values. A search query is modified to include one or more content tags based on the terms in the search query and/or user preferences. The search query is then matched to documents associated with content tags contained in the search query.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to a method for performing context based keyword document searching.

### BACKGROUND OF THE INVENTION

Search engines are a commonly used tool for identifying desired documents from large electronic document collections, including the world-wide internet and internal corporate networks. Conventional search methods typically use keyword searches to identify relevant documents. Documents that match more keywords within a search are often considered more desirable. These documents are typically returned at the beginning of the list of search results.

One limitation of keyword searching is the difficulty in providing a context for the keywords. For example, consider a search query containing the word “pizza.” Documents that typically contain this word also have other words in common such as “delivery”, “pepperoni”, “sauce”, “restaurant” etc. However, it is quite possible that there are documents that contain the word “pizza” prominently, but have nothing to do with the more common use of the word pizza. For instance, a new software technology called “pizza” might be invented by a startup and, therefore, be featured prominently on that companies web page. If this invention is new and not well known then this use of the word “pizza” will not be the likely intent of users when they enter the query pizza, so the results for this search query should not feature this page prominently. Unfortunately, a conventional search engine does not have the ability to distinguish between the new, uncommon usage of the word “pizza” and the usage that is probably desired by the person submitting the search query.

One way to provide context for a keyword search is by adding additional keyword search terms. However, the person submitting a search query may be either unwilling or unable to add enough keywords to provide context for the search. Additionally, simply adding one or more keywords may not adequately represent the true content a user is interested in finding.

In a paper titled “Self Organization of a Massive Document Collection”, (IEEE Transactions on Neural Networks, Vol. 11, No. 3, May 2000, page 574), a method is provided for constructing a self-organized 2-dimensional map to categorize documents. The categorized documents can be keyword searched. Additionally, the individual map units are indexed based on any keywords contained within the map unit.

What is needed is a system and method of performing context based keyword searches. The search system and method should be able to provide search results sorted to match the likely intended context for a search while maintaining a response time similar to the response times of conventional search methods. The search system and method should further be able to incorporate desired user content preferences independent of the terms provided in a search query. Additionally, the system and method should be compatible with conventional search techniques.

### SUMMARY OF THE INVENTION

This invention provides a system and method for performing context based keyword searches while maintaining fast response times. The system and method are compatible with existing search engine technology.

In an embodiment, the invention provides a method for performing a context based document search. In this embodiment, one or more grids of content tiles are constructed, each content tile having a content tag and corresponding to a series of grid feature values. After constructing the one or more grids, a document is searched to determine a series of document feature values for each document. The document feature values are then compared with the grid feature values for each content tile. Based on this comparison, one or more content tags are associated with the document In another embodiment, a document can also be associated with content tags corresponding to the nearest neighbor content tiles. After associating the document with any appropriate content tags, the document can be matched to a search query containing one of the associated content tags.

In an embodiment, the search query is a modified to add the associated content tag. The associated content tag can be selected for addition to the search query based on the keywords contained in the search query, or based on previously determined user preferences.

In another embodiment, the invention provides a method for performing a document search. A grid of content tiles is provided, each content tile having a content tag and being associated with one or more documents. A search query, modified to include at least one content tag, is then matched to one or more documents associated with the content tag.

The invention further provides a system for performing context based document searches. In an embodiment, the system comprises a search engine that also includes a grid builder for constructing a grid of content tiles corresponding to a content space. Each content tile in the concept space also has a series of grid feature values. The system also includes a content tag assignment mechanism for assigning content tags to the content tiles. The system further includes a feature association mechanism for determining a series of feature values for a document and associating the document with content tiles. Additionally, the system includes a keyword matching mechanism for matching a document associated with a content tag to a search query.

In various embodiments, the system can also include a search query modification mechanism for identifying a content tag and then modifying the search query to include the content tag. The content tag can be identified based on the keywords present in the search query, or based on user preferences. In still other embodiments, the system can include a document indexing mechanism for storing associations between content tags and documents. Additionally, the grid builder can further comprise a training mechanism for modifying the grid feature values of the concept tiles based on a comparison with the document feature values of a collection of training documents.

### BRIEF DESCRIPTION OF THE DRAWINGS

FIG. 1 is a block diagram illustrating an overview of a system in accordance with an embodiment of the invention;

FIG. 2 is block diagram illustrating a computerized environment in which embodiments of the invention may be implemented;

FIG. 3 is a block diagram of a concept grid construction module in accordance with an embodiment of the invention;

FIG. 4 is a flow chart illustrating a method for constructing a concept space grid and associating documents with tiles in the concept grid according to an embodiment of the invention; and

FIG. 5 is a flow chart illustrating a method for performing a context based search according to an embodiment of the invention.

### DETAILED DESCRIPTION OF THE EMBODIMENTS

I. Overview

This invention provides a system and method for performing context-based keyword searching of electronic documents. Rather than simply identifying documents containing one or more keywords present in a search query, the invention allows a search engine to identify documents that match the likely intent of a user submitting a search query.

In various embodiments, the invention provides context based keyword searching by associating documents with content tiles on a two-dimensional grid spanning a concept space. Each concept tile in the grid is assigned a concept tag for identification. The concept tag is a character string that is capable of being recognized as a term in a search query. Each concept tile also has a corresponding series of feature values. The series of feature values describe the portion of content space that is covered by a content tile. Preferably, the series of feature values can be expressed as a feature vector.

The grid is constructed so that documents with related subject matter are likely to be associated with concept tiles that are near to each other in the grid. This is accomplished by training the feature values for each concept tile using a set of training documents. A series of document feature values is determined for each document in the training set. One iteration of the training process is performed by comparing the document feature values for each document with the grid feature values for each concept tile in the grid. For each document, the content tile having the grid feature values which are most similar to the document feature values is identified. The grid feature values for this identified content tile, as well as the grid feature values for any nearby content tiles, are then modified to more closely resemble the document feature values. By moving neighborhoods of feature values, correlations between the feature values of neighboring content tiles are developed. Because the feature values of neighboring content tiles will be similar, documents eventually associated with neighboring content tiles will also be similar.

Once a grid has been constructed, documents from a searchable document collection are associated with the content tiles (and corresponding content tags). When a search query is submitted, concept tiles that correspond to the search query are identified. Additionally, any concept tiles corresponding to known user preferences are also identified. The search query is then modified to add any concept tags corresponding to the identified concept tiles. This modified search query is then matched with documents associated with one or more of the concept tags in the modified search query. By using content tags, a search query can be more closely matched with documents having corresponding content while still preserving the speed of using a keyword search algorithm.

In an embodiment, documents which match the concept tags in the search query can be given a higher ranking for display in the results. In other words, documents matching the concept tags will be displayed closer to the top of the search results than documents which do not match a concept tag in the search query. In another embodiment, the concept tags can be used as required keywords in the search. In such an embodiment, documents which do not match a concept tag in the search query are not displayed in the listing of search results.

To improve the response time for responding to a search query, documents can be “pre-searched” to determine if a document should be associated with one or more concept nodes. Any associations between a document and a concept node (including the assigned concept tag) are then stored in a convenient format for quick retrieval. When a search query is submitted, the stored search results are consulted to determine which documents are associated with a given concept tag.

II. General Operating Environment

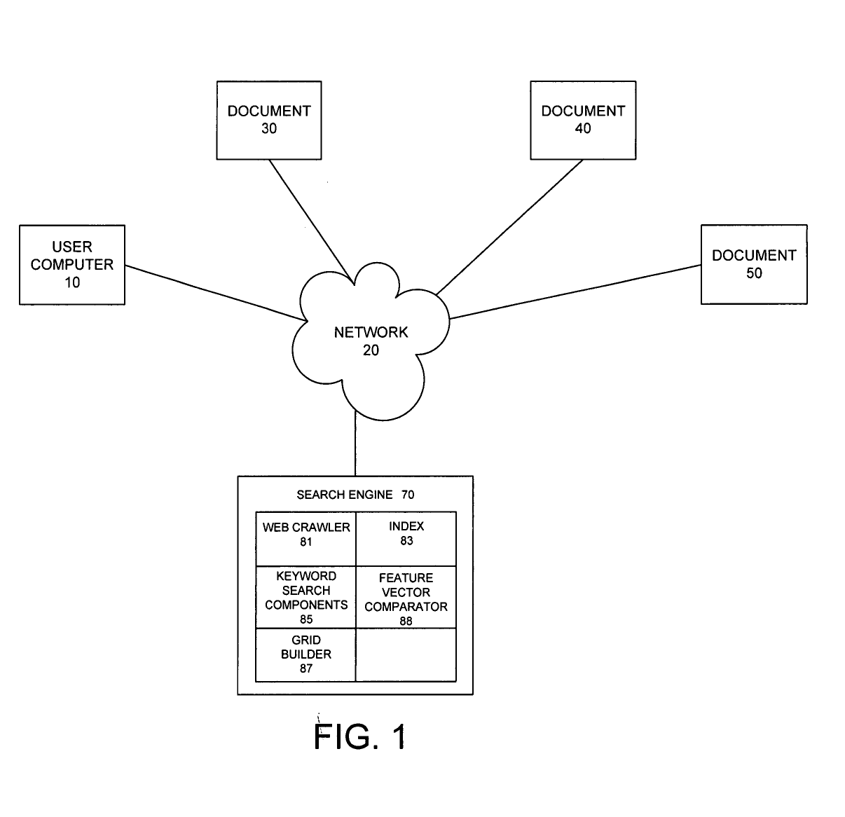

FIG. 1 illustrates a system for performing context based keyword searches according to an embodiment of the invention. A user computer 10 may be connected over a network 20, such as the Internet, with a search engine 70. The search engine 70 may access multiple web sites 30, 40, and 50 over the network 20. This limited number of web sites is shown for exemplary purposes only. In actual applications the search engine 70 may access large numbers of web sites over the network 20.

The search engine 70 may include a web crawler 81 for traversing the web sites 30, 40, and 50 and an index 83 for indexing the traversed web sites. The search engine 70 may also include a keyword search component 85 for searching the index 83 for results in response to a search query from the user computer 10. The search engine 200 may also include a grid builder 87 for constructing a grid of concept tiles, training the series of feature values associated with the concept tiles, and assigning concept tags to the concept tiles. Alternatively, grid builder 87 can be a separate program. A feature vector comparator 88 may be included to associate documents with one or more concept nodes. The feature vector comparator 88 can also associate a search query with corresponding concept nodes.

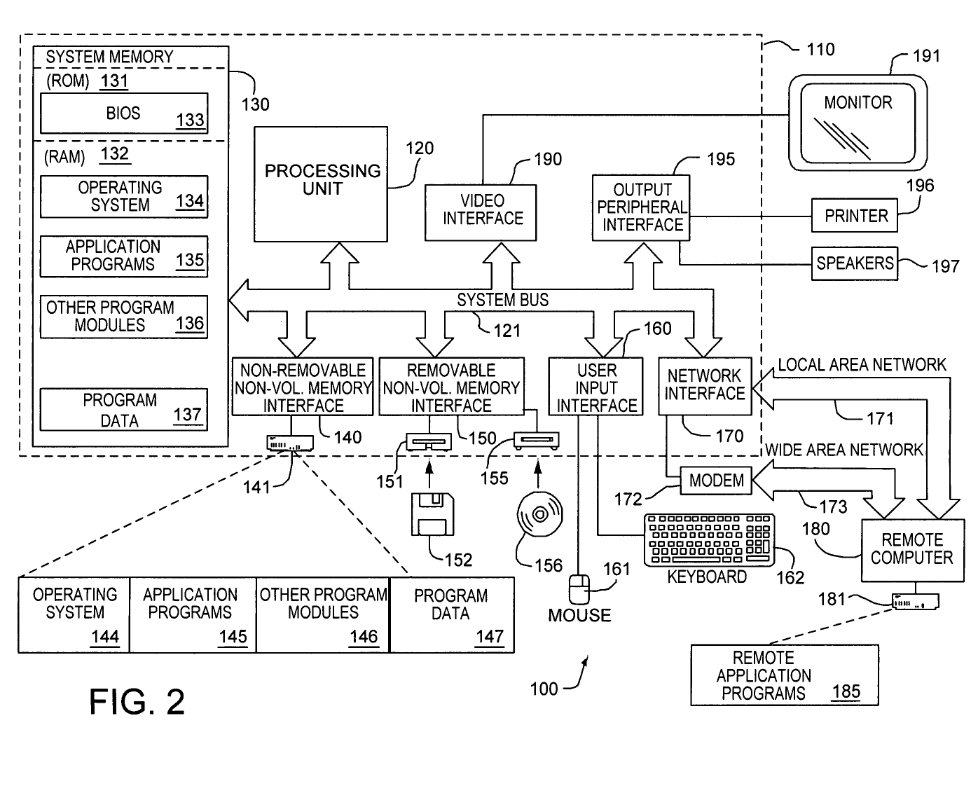

FIG. 2 illustrates an example of a suitable computing system environment 100 for implementing context based searching according to the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 2, the exemplary system 100 for implementing the invention includes a general purpose-computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/nonremovable, volatile/nonvolatile computer storage media. By way of example only, FIG. 2 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

III. Searching Training Documents to Identify Word Phrase Basis Vectors

In various embodiments, a precursor step to performing the method of the invention is identifying the words and word phrases that will used in determining the feature values for documents and the grid content tiles. In embodiments where feature values are represented as feature vectors, the words and word phrases that serve as basis vectors must be identified. In this invention, a word represents a searchable string of characters. A word phrase represents two or more words separated by a space. In preferred embodiments, the basis vectors include words, word phrases containing two words (word pairs), and word phrases containing three words (word triplets).

The words and word phrases used as basis vectors can be identified by any convenient method. In an embodiment, the basis vectors can be selected from a previously determined list of words and word phrases. In another embodiment, the basis vectors are determined by analyzing the words and word phrases found in a group of training documents. The training documents can be any document collection that can be keyword searched. Preferably, the training documents are representative of a desired searchable document collection, (i.e. the collection of documents that will be searched when a user submits a search query). In an embodiment, at least a portion of the training documents are included in the searchable document collection. In another embodiment, the number of training documents is at least 0.05%, or at least 0.1%, or at least 0.5%, or at least 1.0% of the total number of documents in the searchable document collection.

For a word or word phrase to be useful as a search term, the word or word phrase should appear preferentially in a small subset of the training documents. For example, if a word or word phrase appears in one or only a few of the training documents, the word or word phrase is likely to be helpful as a search term. Similarly, a word that appears in many documents, but a large number of times in only a few documents, may also be an effective search term. One way to identify such words and word phrases in the training documents is to determine a “keyword value” for a word or word phrase. A keyword value for a word phrase can be determined, for example, by comparing the frequency of occurrence for a word or word phrase in an individual document with the average frequency of occurrence in all documents. This provides a numerical keyword value for a given word or word phrase in a single document. A word or word phrase that has a high keyword value in one or more documents is likely to be a good choice as a basis vector. In an embodiment, the keyword value can be expressed as a numerical value, and words or word phrases having keyword values that are higher than a predetermined threshold can be selected as basis vectors. Those of skill in the art will recognize that many possible keyword values could be calculated.

In an embodiment, the keyword value for each word or word phrase in each document is generated using the following formula:

$${P}_{ij} = {tf}_{ij} log ( \frac{N}{d {c}_{j}} )$$

where Pᵢⱼ is the numerical value for word or word phrase “j” in document “i” of the document collection, tfᵢⱼ is the total frequency of occurrence for word or word phrase “j” in document “i”, N is the total number of documents in the collection, and dcⱼ is the number of documents containing the word or word phrase “j”.

For a word or word phrase “j,” the keyword value Pᵢⱼ is calculated for each document “i” in the training document collection. Note that this requires calculation of both the number of occurrences of a word “j” in the document “i” as well as calculation of the total number of documents containing the word “j”. The maximum Pᵢⱼ value for the word or word phrase is then compared with a predetermined threshold value. If the maximum Pᵢⱼ value is greater than the predetermined threshold, the word or word phrase is selected to be part of the document feature vector. Note that based on the above formula, a word that appears in every document in a collection will always have a Pᵢⱼ value of zero, because when dcⱼ=N, the logarithm term will become zero. Thus, even if a word “j” appears an unusually large number of times in only a few documents, at least some documents in the collection must not contain the word in order to get a non-zero Pᵢⱼ value. By contrast, as a document collection becomes larger, the possible value of the logarithm term will increase. Thus, the larger the document collection is, the larger the maximum Pᵢⱼ value will be for a word that appears in only one document.

In an embodiment, the training documents are first analyzed to determine the Pij values for all single words in all documents. The process is then repeated for all word pairs and word triplets in the training documents.

### IV. Constructing a Feature Vector

After identifying the words and word phrases that are useful as search keywords, a series of feature values can be determined for each training document. In other words, once the number of basis vectors (words and word phrases) has been determined, a feature vector can be created for each training document. A feature vector is a multi-dimensional vector having a number of dimensions equal to the number of basis vectors. Because the basis vectors represent words and word phrases, in an embodiment the numerical coefficients of a feature vector are based on the frequency of occurrence of a word or word phrase in a document.

In an embodiment, the feature vector for each document “i” is defined as

$${\overline{D}}_{j} = \sum {tf}_{ij} log ( \frac{N}{d {c}_{j}} ) \cdot {\hat{w}}_{j}$$

where tfᵢⱼ is the number of times word “j” appears in document “i,” N is the total number of documents in the collection, dcⱼ is the number of documents in the entire collection that contain the word “j,” and ŵⱼ is the unit vector for word “j” defined as:

$${\hat{w}}_{k} \cdot {\hat{w}}_{l} = \{ \begin{matrix}1 , k = l \\ 0 , k \neq l\end{matrix}$$

Although the formula for keyword value is incorporated into the above definition for the feature vector, in another embodiment the feature vector can be defined independently of the keyword value.

In an embodiment where the basis vectors may be composed of words, word pairs, and word triplets, the feature vector is constructed by first searching a document to identify all occurrences of single word basis vectors. The document is then searched to determine all two word basis vectors, and finally all three word basis vectors. In another embodiment, a document may be searched to identify the basis vectors in any convenient order.

V. Forming Concept Grids and Concept Tiles

In various embodiments, another precursor step to performing the method of the invention is the formation of at least one grid that spans concept space. Preferably, the grid is a 2-dimensional grid. The concept grid is composed of grid elements or concept tiles, which can be any combination of shapes which fill a concept space. In an embodiment, the concept tiles can be triangles, squares, parallelpipeds, hexagons, or any other regular, space-filling shape in 2 dimensions. In another embodiment, the concept tiles can have multiple shapes and dimensions that lead to filling of a 2-dimensional space. In yet another embodiment, the concept grid spans a 3-dimensional space. In such an embodiment, the concept tiles preferably have regular 3-dimensional shapes, such as cubes.

Because the concept tiles are arranged to fill a selected space, each concept tile will have a list of “nearest neighbor” concept tiles. In an embodiment, the nearest neighbor concept tiles are the group of tiles that share a common boundary with a give concept tile. For example, in a 2-dimensional grid with square concept tiles of uniform size, each concept tile will have a total of eight nearest neighbor tiles. Similarly, in a grid of regular hexagons of uniform size, each concept tile will have six nearest neighbor tiles. In some embodiments, concept tiles located at the edge of a grid may have a lower number of nearest neighbors. In alternative embodiments, the grid can be constructed to have a toroidal shape which eliminates the edge of the grid along one dimension. For example, in a 2-dimensional grid having 4 edges (i.e., top, bottom, left, and right), the concept tiles on the left edge would be adjacent to the concept tiles on the right edge. Thus, a concept tile located on the right edge of the grid, would include concept tiles from the left edge of the grid in the nearest neighbor list, and vice versa. Those of skill in the art will recognize that other special cases can arise at the edges of the grid.

The number of concept tiles in a concept grid can vary. In an embodiment, the number of concept tiles is selected based on the number of basis vectors found in a set of training documents.

During or after formation of a grid, concept tags are assigned to the concept tiles. A concept tag is a text string that identifies a concept tile within a grid. The text string can be any combination of characters that can be used as a search term in a search query. In preferred embodiments the concept tag includes identifying information about the concept tile. For example, the concept tag can include information about which grid the concept tile is in, the size of the concept tile, the shape of the concept tile, and the location of the concept tile in the grid.

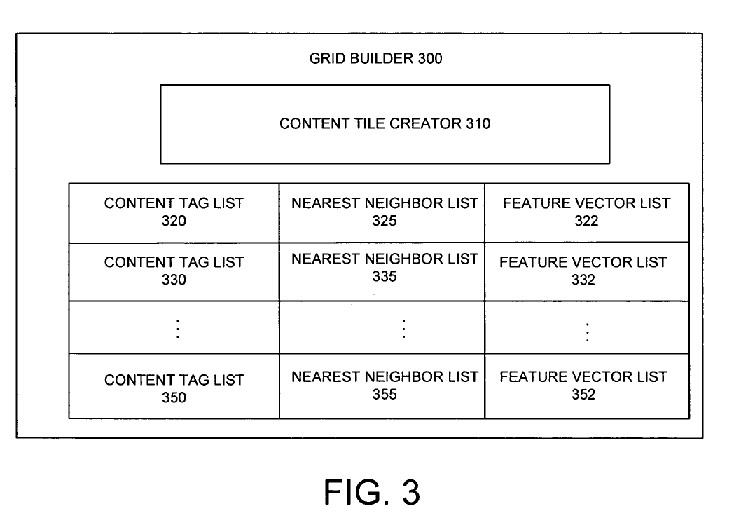

FIG. 3 schematically depicts a grid builder 300 according to an embodiment of the invention. Grid builder 300 includes a content tile creator 310 for constructing the initial space-filling grid of content tiles. In an embodiment, grid builder 300 also includes one or more pairs of concept tag lists and nearest neighbor lists. A concept tag list (such as concept tag list 320, 330, and 350) contains the concept tag identifiers for each content tile in a single grid. In an alternative embodiment, a single concept tag list could contain all location tags for multiple grids. A nearest neighbor list (such as nearest neighbor list 325, 335, and 355) provides a listing of the nearest neighbor content tiles for each concept tile in a grid. Although the concept tag lists and nearest neighbor lists are shown here as data structures, in another embodiment the concept tag for a content tile and the nearest neighbor content tiles can be calculated as needed. In such an embodiment, the creation of concept tags for the concept tiles conforms to a pattern so that the concept tag can be determined using an algorithm. For example, if multiple grids are desired that each span the same concept space but with different resolution, the concept tags for concept tiles in lower resolution grids may be calculated based on the concept tags of a corresponding concept tile in a higher resolution grid. In still another embodiment, grid builder 300 includes a grid feature vector list (such as feature vector list 322, 332, and 352.) The grid feature vector list contains the coefficients for the feature vector corresponding to each content tile in the grid.

In an embodiment, multiple grids can be constructed that cover the same content space. The multiple grids can have the same or different starting points. The grids can also have different sizes and shapes for the location tiles. For example, multiple grids for a content space could be constructed to have content tiles with differing resolutions. A grid with smaller content tiles could have square tiles that correspond to half of the grid size of the content tile in the next larger grid. This would cause 4 squares in the smaller grid to correspond to one square of the next larger grid. This pattern can be repeated to create successively larger grids.

In an exemplary embodiment, three grids can be constructed to cover the same concept space. In the highest resolution grid, one of the content tiles corresponds to a tile location that is in the 47^{th} row and the 65^{th} column. The lower resolution grids are each a factor of 4 lower in resolution. In other words, one of the lower resolution grids contains only ¼ as many tiles as the highest resolution grid, while the other grid contains only 1/16 as many tiles as the highest resolution grid. In this embodiment, the concept tags for the concept tiles corresponding to tile 47, 65 in the highest resolution grid are

ct001x0047y0065

ct004x0011y0016

ct016x0002y0004

The “ct” indicates that the grid is a concept space grid. The next 3 numbers indicate the size of the individual concept tiles, with smaller tiles corresponding to higher resolution. The four digits following the “x” represent the tile number along one direction (such as a row or the x direction). Similarly, the four digits following the “y” represent the tile number along a second direction (such as a column or the y direction). Note that the tile number of tiles in the lower resolution grids can be determined by dividing the tile number of the higher resolution grid by the size number for tiles in the lower resolution grid.

VI. Training the Feature Vectors

After constructing a grid in concept space, the grid feature vectors corresponding to the content tiles are trained. The training of the grid feature vectors can be conducted using any algorithm suitable for forming a self-organizing map. Training the feature vectors should cause content tiles that are closer to each other to have similar or related content.

In an embodiment, training of the grid feature vectors begins by assigning initial values to the coefficients for each grid feature vector. Any convenient set of initial coefficients can be assigned. In an embodiment, the coefficients of the grid feature vectors are seeded with small random values. In another embodiment, the coefficients of the grid feature vectors can be sparsely populated, so that only a few coefficients have non-zero values in each initial feature vector.

In an embodiment, after assigning the initial coefficients for the grid feature vectors, the grid feature vectors are trained using the document feature vectors for the training documents. To train the grid feature vectors, the feature vector for a document is compared with each of the grid feature vectors. The grid feature vector with the most similarity to the document feature vector is identified. This identified grid feature vector is modified to more closely resemble the document feature vector. The grid feature vectors for the nearest neighbor content tiles are also modified (to a lesser degree) to more closely resemble the document feature vector. This process is repeated until the feature vectors for all documents in the training collection. At this point, one iteration of training is complete.

In a preferred embodiment, the comparison of a document feature vector with a grid feature vector comprises determining a mathematical dot product of the grid feature vector and a document feature vector. A dot product provides a convenient comparison tool, as the grid feature vector that is most similar to a training document feature vector will produce the highest dot product value. After identifying the most similar grid feature vector, the grid feature vector is modified to move proportionally closer to the document feature vector. In an embodiment, the difference between the grid feature vector and the document feature vector is determined. A percentage of this difference is then added into the grid feature vector. The percentage of the difference added to the grid feature vector is referred to as the learning rate. In an embodiment, the learning rate can be 10% or less, or 5% or less, or 3% or less, or 1% or less. In another embodiment, the learning rate decreases during the course of training, such as after a predetermined number of training iterations.

In addition to modifying the grid feature vector with the highest dot product value, other nearby grid feature vectors are also modified. Modifying the grid feature vectors of neighboring content tiles allows nearby content tiles to correspond to related subject matter. In an embodiment, the grid feature vectors for each nearest neighbor content tile are modified in the same manner as described above, but preferably with a lower learning rate. In another embodiment, grid feature vectors for nearby content tiles are modified based on a Gaussian (or other function) profile for the learning rate. In such an embodiment, the number of nearby content tiles modified depends on the rate of drop-off of a Gaussian function. The width of the Gaussian function can also vary during the course of training if desired.

After multiple iterations, the grid feature vectors should converge on a stable solution. Convergence can be detected based on the amount of change in the grid feature vectors after a full iteration of training. If there is no change or a sufficiently small change in the grid feature vectors between consecutive iterations, the grid feature vectors are considered converged.

VII. Pre-Searching a Document Collection

Once the grid feature vectors for a content grid are converged, a pre-search can be performed on a group of searchable documents to determine which documents should be associated with which content tiles. Pre-searching documents allows computationally expensive steps, such as forming document feature vectors, to be performed before a user enters a search query. Additionally, the type and number of searchable keywords in a document can also be identified and stored for later use.

In an embodiment of the invention, performing a pre-search includes creating a feature vector for all documents available in a searchable document collection. The feature vectors are preferably constructed in the same manner as described above. Note, however, that a searchable document collection will typically contain more documents than a training document collection. As a result, the feature vector for a document in a training document collection may not be the same as the feature vector for an identical document in a searchable document collection.

After determining a feature vector for each document in a searchable document collection, the document feature vectors are used to determine which content tiles, if any, should be associated with a document. A vector dot product is calculated for the document feature vector with each grid feature vector. For each dot product value that is greater than a predetermined threshold, the corresponding content tile is associated with the document. In other words, if a document has a threshold amount of similarity to the content represented by a content tile, the document is associated with the content tile. In an embodiment, associating a document with a content tile comprises associating the document with the content tag for the content tile.

In various embodiments, multiple grids are constructed that correspond to the same content space, with each grid having successively larger content tiles. The grids with successively larger content tiles are effectively lower resolution grids, with a single lower resolution content tile corresponding to multiple higher resolution content tiles. In such an embodiment, during a pre-search the document feature vectors would be compared with the grid feature vectors for the content grid with the highest resolution. When a content tile from this highest resolution grid is associated with a document, the corresponding content tiles from each of the lower resolution grids can also be associated with the document.

In an embodiment, the results of the pre-search, such as the association of content tiles with documents, are stored in a manner that allows for easy retrieval of data when responding to a search query. One example of a data structure suitable for storing pre-search results is an inverted index. An inverted index is a list of potential searchable terms or keywords, and a list of documents that contain those keywords. When a document is pre-searched, the document is associated with each keyword present in the document. The search terms can be individual words, groups of words, or any other string of characters that can be used as part of a search query. When a search term is subsequently used in a search query, the search term can be quickly found in the inverted index. Each document associated with the search term is returned as a match. In various embodiments of this invention, the inverted index is also used to associate documents with the location tags of content tiles. Because the location tags have the form of a keyword, the location tag for each content tile can be included in the inverted index just like any other keyword. When a document is associated with a content tile, the inverted index is updated to associate the document with the location tag for that content tile.

The process of pre-searching documents continues until all desired searchable documents have been searched and associated with terms in the inverted index. The inverted index is now ready for use in responding to search queries. To maintain the inverted index, the process of pre-searching documents and associating documents with content tiles can be repeated periodically, such as daily, or weekly, or monthly, or yearly. In another embodiment, the inverted index can be updated according to any convenient schedule. In still another embodiment, the inverted index can be updated based on the occurrence of an event, such as when a sufficient number of new searchable documents become available for pre-searching.

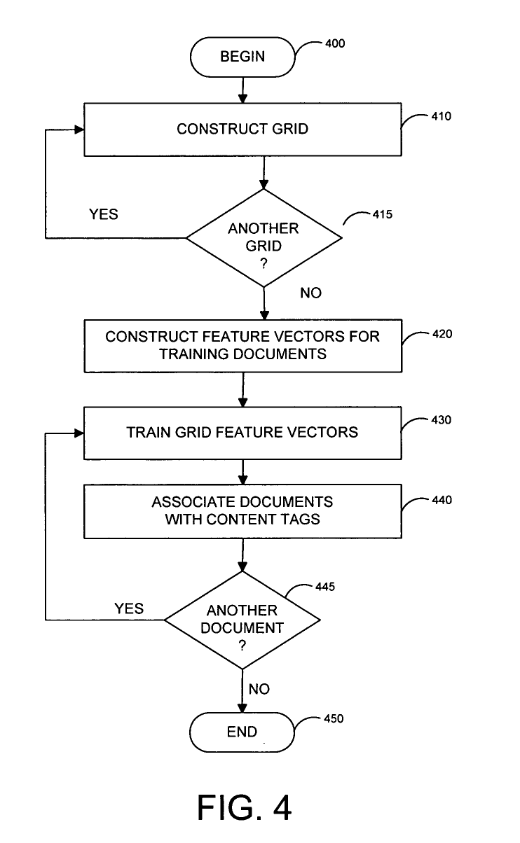

FIG. 4 depicts a flow chart of an embodiment of the invention that incorporates the tasks described above. First, one or more grids spanning content space are constructed 410. In the embodiment shown in FIG. 4, the number of content tiles is selected prior to determining the number of basis vectors. Next, a group of training documents is searched to identify the words and word phrases that will be used as the basis vectors for training the content space grids. Using the basis vectors, a feature vector is constructed 420 for each training document. The training document feature vectors are then used 430 to train the grid feature vectors for each content tile. After the grid feature vectors are trained, a desired searchable document collection is pre-searched to index each document based on the keywords in the document. During the pre-search, the documents are also associated 440 with any appropriate content tiles. The concept space grids and indexed documents can now be used to respond to any search queries submitted by a user.

This invention will be further described below in an embodiment involving an inverted index for holding the results of a pre-search. This embodiment is only illustrative, however, and other data structures and/or methods for storing the results of a pre-search may also be used with this invention.

VIII. Adding Location Tags to a Search Query

In various embodiments of the invention, search queries provided by a user are associated with one or more content tiles from the content grid. The content tiles that are associated with the search query can be determined by any of a variety of methods. In an embodiment, a search query is associated with content tiles based on the keywords provided in the search query. In such an embodiment, a search query is analyzed to identify any words or word phrases that correspond to the keyword basis vectors used in forming a feature vector. The search query is analyzed by reading the search query from left to right. If the basis vectors include multi-word phrases, the analysis starts with the longest possible phrase, and then shorter phrases are searched to identify any potential basis vector matches. As an example, in an embodiment the basis vectors can include words, word pairs, and word triplets. To analyze a search query, the first three words starting from the left of the query would be compared with any three word basis vectors. If no match is found, the first two words would then be compared with two word basis vectors, and then the first word compared with the one word basis vectors. As soon as a match is found, the analysis would move forward in the search query past the word(s) comprising the basis vector. This process is repeated until all words are identified as either belonging to one or zero basis vectors.

After identifying any basis vectors present in the search query, any content tiles that correspond to the basis vector are determined. In an embodiment, the content tiles corresponding to a basis vector are determined by first calculating a dot product between the basis vector and the grid feature vector for each content tile “i”. The value of this dot product nᵢ represents the overlap between the basis vector and the content tile “i”. The dot product values nᵢ for the basis vector with each grid feature vector are then used to calculate a “certainty value” for each content tile using the formula

$$C = log ( {N}_{c} ) + {\sum }_{i} \frac{{n}_{i}}{n} log ( \frac{{n}_{i}}{n} )$$

where C is the certainty, N_{c} is the total number of content tiles in the grid, nᵢ is the dot product value of the basis vector with the grid feature vector for content tile “i,” and n is the sum of the dot products of the basis vector with the grid feature vector for all content tiles. Based on the above formula, basis vectors which overlap significantly with only one or a few basis vectors will have higher certainty values.

The calculated certainty values can be used to determine whether a keyword in a search query is associated with one or more content tiles. In an embodiment, if the certainty value for a given content tile is above a threshold value, the content tile is associated with the search query. The search query is then modified to include the location tag assigned to the content tile. Otherwise, the content tile is not associated with the search query. In another embodiment involving multiple grids with different resolutions, multiple thresholds can be used to determine which content tiles to associate with the search query. If the certainty is above a first threshold, the location tag for the content tile is added to the search query. If the certainty is below the first threshold but above a second threshold, a location tag for a content tile from a lower resolution grid can be added to the search query. In this situation, the search query is effectively associated with a more general type of content, as opposed to the more specific content found in the content tiles of the higher resolution grid. If the certainty is below all threshold values, then the search query is not modified.

In another embodiment, the above calculations for identifying basis vectors that have strong overlap with the grid feature vectors of content tiles can be performed as part of the pre-search. In this embodiment, the overlap and certainty calculations are performed prior to receiving a search query. When a certainty calculation shows that a basis vector should be associated with a content tile, the content tag for that content tile is associated with the basis vector keyword in an index. The index can be the same inverted index used to associate documents with content tiles, or it can be a separate data structure. In this type of embodiment, when a search query is submitted to a search engine, any content tiles that should be associated with the search query can be identified by simply consulting this previously generated index.

In yet another embodiment, multiple content tags can be added to the search query for each content tile associated with the search query. In this embodiment, the search query is modified by adding the location tag for a content tile as described above. In addition, the content tag for each nearest neighbor content tile is also added to the search query. In an alternative embodiment, this same function can be achieved when the inverted index is constructed during the pre-search. When a content tile is associated with a document, the document is also associated with the nearest neighbor content tiles. This means that the document is also listed in the inverted index in association with the content tags for the nearest neighbor content tiles.

ix. Adding Content Tags to Search Queries Based on User Preferences

In still another embodiment, a search query can be associated with content tiles based on user preferences. Content tiles (and content tags) corresponding to user preferences can be determined by various methods. In an embodiment, user preferences are determined based on explicit entry of preferences by a user in the form of keywords. The preference keywords provided by the user can be associated with content tiles using the methods described above. Any search query submitted by the user can then be modified to include the location tags corresponding to the user preferences. In another embodiment, user preferences can be determined based on the previous documents viewed by a user. For example, any documents visited by a user can be tracked. The content tags associated with these documents are stored. The content tags can then be analyzed to determine the frequency with which a user views documents associated with a specific content tag. If the user views documents associated with a content tag with a high enough frequency, the content tag can be associated with any future search queries submitted by the user. In still another embodiment, the user history can be limited to include only documents viewed during a specific activity, such as limiting the history to only documents viewed as part of the results of a search query.

Once a user preference is known, the content tag corresponding to the user preference can be stored in a location associated with the search engine. The user preferences are then retrieved if/when the user is identified to the search engine, such as by providing a password. Alternatively, the user preferences can be stored locally on a user's computer, such as in a web browser cookie.

VII. Matching Documents to a Search Query

Content tags added to a search query can be used to modify the response to the query in various ways. In an embodiment, the content tags are used as mandatory terms. Only documents that match the content tags in the search query are provided to the user as matches. In such an embodiment, the content tags are treated similarly to other terms in the search query. For example, if a search query is modified to include one or more content tags, then only documents associated with at least one of the content tags will be returned as a search result.

In another embodiment, the content tags in the search query are used only to prioritize the documents matching other terms in the search query. In such an embodiment, the matching the content tags in the search query does not include or exclude a document. Instead, documents which match a content tag are assigned an increased value in determining the order to display results to the user. Various schemes for prioritizing the display of search results are possible. In one embodiment, the display priority for a document can be based on the total number of matching search terms in a search query. In this situation, documents associated with a content tag would receive the same priority increase as if any other search term were matched. In another embodiment, the priority increase for matching a content tag can be separate from the priority increase from matching a content tag. In still another embodiment, the increase in priority value for matching a content tag from a higher resolution grid can be greater than the increase in priority value for matching a location tile in a lower resolution grid.

In still another embodiment, the results of a search query can be provided in a format that allows a user to switch from prioritizing based on content tags to requiring content tags as part of a search query match. As an example, consider an initial search query that matches a number of documents, with two of the matching documents also matching separate content tags that were added to the search query. Due to the increased priority from matching a content tag, the two documents matching the content tags are displayed to the user at the top of the results list. Additionally, the two documents matching a content tag from the search query also have an additional link for requesting additional matches having similar content (i.e., documents that are associated with nearby content tiles). If the user selects the link for additional matches, the search query would be submitted again with two differences. First, any content tags added to the search query would be replaced with the content tag selected by the user, plus the content tags for all nearest neighbor content tiles. The search would then be processed under the constraint that a document must be associated with one of the content tags in the search query to be displayed as a match.

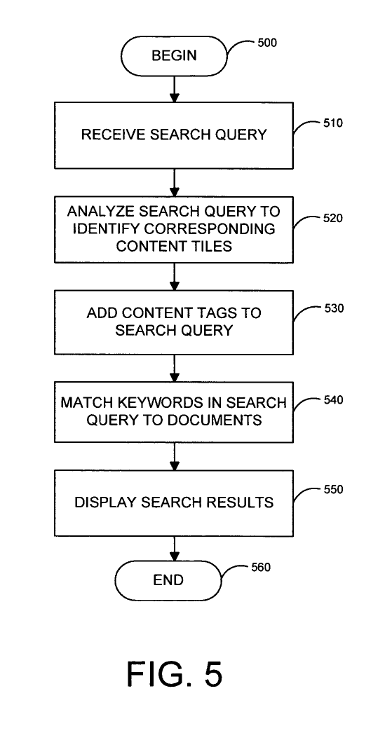

FIG. 5 depicts a method for returning search results to a user according to an embodiment of the invention. When a search query is received 510 by a search engine, a the search query is analyzed 520 to identify any corresponding content tiles. The search query is then modified 530 to include identified content tiles, as well as any content tiles corresponding to known user preferences. In an alternative embodiment, the search query can be modified to include only the user preference content tiles, or only the content tiles identified based on the terms in the search query. The search query is then matched 540 to one or more documents based on the content tags and other keywords contained in the search query. When the documents are displayed, documents matching 540 one of the location tags can be displayed 550 at the beginning of the list using any of a variety of ranking methods. For example, the documents matching the most location tags could be listed first, or the documents matching the tag with the highest resolution could be listed first.

Having now fully described this invention, it will be appreciated by those skilled in the art that the invention can be performed within a wide range of parameters within what is claimed, without departing from the spirit and scope of the invention.

What is claimed is:

1. A method of performing a context based search, comprising:
constructing a grid of content tiles, each content tile having a content tag and corresponding to a series of grid feature values;
searching a document to determine a series of document feature values;
comparing the document feature values with the grid feature values for each content tile;
associating one or more content tags with the document based on the comparison of document feature values and grid feature values;
matching the document with a search query containing at least one of the associated content tags.

2. The method of claim 1, further comprising providing the matched document in response to the search query

3. The method of claim 2, where the matched documents are provided as a prioritized list.

4. The method of claim 3, wherein the matched documents are prioritized based on the number of content tag matches for each document.

5. The method of claim 1, further comprising:
modifying the search query by adding one or more content tags.

6. The method of claim 1, further comprising
comparing the search query with the grid feature values of each content tile;
selecting one or more content tags to add to the search query based the comparison of the search query with the grid feature values; and
modifying the search query by adding the one or more content tags.

7. The method of claim 1, further comprising:
selecting one or more content tags to add to the search query from a list of stored content tags corresponding to user preferences; and
modifying the search query by adding the one or more content tags.

8. The method of claim 1, wherein associating the document with one or more content tags comprises associating the document with the content tag corresponding to a first content tile and the content tags corresponding to the nearest neighbor content tiles of the first content tile.

9. The method of claim 1, wherein the document contains a plurality of keywords, the one or more associated content tags being different from the keywords contained in the document.

10. A computer readable medium storing computer executable instructions for performing the method of claim 1.

11. A method for performing a document search, comprising:
providing a grid of content tiles, each content tile having a corresponding content tag and being associated with one or more documents;
modifying a search query to include at least one content tag; and
matching the modified search query with the one or more documents associated with the at least one content tag.

12. The method of claim 11, wherein the one or more documents each contain a plurality of keywords, the at least one content tag not being a keyword contained in the one or more documents.

13. The method of claim 11, further comprising providing the one or more matching documents in response to the modified search query.

14. The method of claim 13, where the one or more matching documents are provided as a prioritized list.

15. The method of claim 14, wherein the matched documents are prioritized based on the number of content tag matches for each document.

16. A computer readable medium storing computer executable instructions for performing the method of claim 11.

17. A search engine for performing context based document searches comprising:
a grid builder for constructing a grid of content tiles, each content tile having a series of grid feature values;
a content tag assignment mechanism for assigning a content tag to each content tile;
a feature association mechanism for determining a series of feature values for a document and associating the document with one or more content tiles; and
a keyword matching mechanism for matching a document associated with a content tag to a search query.

18. The system of claim 17, further comprising a search query modification mechanism for identifying a content tag and modifying the search query to include the identified content tag.

19. The system of claim 17, further comprising a document indexing mechanism for storing associations between content tags and documents.

20. The system of claim 17, wherein the grid builder further comprises a training mechanism for modifying the grid feature values of the concept tiles based on a comparison with document feature values of a collection of training documents.
